(19) United States
(12) Patent Application Publication
(10) Pub. No.: US 2024/0238784 A1
(43) Pub. Date: Jul. 18, 2024

(54) DEVICE FOR ALLOWING PRESSURIZATION OF FLUID IN A MICROFLUIDIC DIAGNOSTIC DEVICE

(71) Applicant: Burst Diagnostics LLC, Fort Collins, CO (US)

(72) Inventors: Nathan Henry, Windsor, CO (US); Charles S. Henry, Fort Collins, CO (US); Cody Carrell, Sun Prairie, WI (US)

(21) Appl. No.: 18/289,707

(22) PCT Filed: May 11, 2022
(86) PCT No.: PCT/US22/28800

§ 371 Date: Nov. 6, 2023

Related U.S. Application Data
(60) Provisional application No. 63/201,804, filed on May 13, 2021.

(51) Int. Cl. B01L 3/00; G01N 1/10

(52) U.S. Cl. CPC B01L 3/50273; G01N 1/10; B01L 2200/027; B01L 2200/0689; B01L 2200/16; B01L 2300/044; B01L 2400/0487; B01L 2400/0638

(57) ABSTRACT

The present invention includes improved systems, methods, and devices to introduce a pressurized biological sample into a microfluidic testing device. In one embodiment, a sample collector containing a biological sample to be tested may be secured to an adaptor. The sample collector containing a biological sample may be introduced to an interface channel containing a reaction mixture, wherein the adaptor forms a seal with the interface channel. Depression of the adaptor generates a pressure force within the interface channel that may be used to introduce the sample to a microfluidic testing device, and further drive the flow of the biological sample through the microfluidic testing device.

### CROSS-REFERENCE TO RELATED APPLICATIONS

This International PCT application claims the benefit of and priority to U.S. Provisional Application No. 63/201,804 filed May 13, 2021, the specification, claims and drawings of which are incorporated herein by reference in their entirety.

### TECHNICAL FIELD

The present invention is generally directed to the field of diagnostic devices, and in particular to microfluidic devices and associated methods for the pressurized introduction of a liquid sample into a microfluidic device.

### BACKGROUND

Traditional single-use microfluidic diagnostic devices typically rely on capillary action or an additional external pumping device to direct and control the flow of a liquid sample through the device. Microfluidic devices such as lateral flow assays use an absorbent material, such as nitrocellulose, to facilitate the flow of a liquid sample across the absorbent material. Other microfluidic devices use microfluidic pathways formed by one or more fluid channels to allow the flow of liquid samples through the device. The dimensions and shape of these fluid channels allows the device to manipulate the natural capillary action of the liquid sample to control the overall flow through the system. Another type of microfluidic diagnostic device uses a reader that incorporates a pump to force a fluid sample through the device. Use of a pump can overcome the low flow velocity of traditional capillary driven devices, however they also add manufacturing complexity and significant cost to the final diagnostic device. The addition of mixing, washing, or filtering steps into traditional microfluidic diagnostic testing devices can increase sensitivity and accuracy, as well as overall speed of the test to be performed, however, addition of these features typically requires the test to be run in a laboratory setting by a trained technician or through the use of specialized laboratory equipment.

Microfluidic devices that relay on capillary action have proven to be effective, however they are often prohibitively time intensive, especially if multiple steps are involved in the reaction or the sample solution has a high viscosity. For example, biological samples such as urine, which have a consistent, low viscosity are able to quickly flow through traditional microfluidic devices in a repeatable manner. However, biological samples such as saliva or mucus which exhibit a high viscosity have difficulty flowing through traditional microfluidic devices in a repeatable and consistent manner. This variability in viscosity can delay test results by more than a factor of three, or in more serious cases of inconsistent viscosity between samples or subjects can cause false test results.

Considering the foregoing, there exists a long-felt need for a simple and inexpensive microfluidic diagnostic device that can efficiently direct the flow of a variety of biological samples into a microfluidic device to be tested.

### SUMMARY OF THE INVENTION

In one aspect, the present invention includes a novel microfluidic diagnostic device configured to efficiently introduce a pressurized sample into a microfluidic testing device. In one preferred aspect, a microfluidic diagnostic device (also referred to herein generally as a microfluidic device, or device of the invention) includes a sample collector containing a biological sample to be tested, that may further be secured to an adaptor. The sample collector containing a biological sample and adaptor components of the invention may be introduced to an interface channel containing a reaction mixture, wherein the adaptor is configured to form a seal with the interface channel.

In another aspect, the microfluidic diagnostic device of the invention includes a membrane placed between the reaction mixture and a microfluidic testing device. The membrane of the invention may be configured to perforate in response to an applied pressure force and allow the reaction mixture containing the biological sample to be introduced into the microfluidic testing device. In a preferred aspect, the adaptor of the invention is depressed into the interface channel creating a pressurized internal environment. Once a threshold pressure is achieved within the interface channel, the membrane of the invention is perforated allowing pressurized fluid communication between the reaction mixture containing the biological sample and an exemplary microfluidic testing device.

In another aspect, the microfluidic diagnostic device of the invention includes a filter configured to filter the reaction mixture containing the biological sample prior to its introduction into an exemplary microfluidic testing device. The filter of the invention may be positioned between the membrane and internal aperture of an interface channel such that upon perforation of the membrane, the reaction mixture containing the biological sample flows through the filter. In alternative embodiments, the filter of the invention may be positioned between the reaction mixture and the membrane, such that upon perforation of the membrane, the reaction mixture containing the biological sample flows through the filter prior to passing through the perforated membrane.

Additional aspects of the invention may include one or more biological samples, preferably from a mammal, and more preferably a human subject, which may include a bodily fluid from a subject selected from the group consisting of: blood, serum, urine, saliva, tissues, cells, and organs, or a combination of the same.

Additional aspects of the invention may include a microfluidic diagnostic device having one or more sample collectors which may comprise a specimen collection swab (also referred to generally as a swab). In a preferred aspect, the specimen collection swab of the invention may be selected from the group consisting of: a flocked swab, a cotton swab, a foam swab, a rayon swab, an oropharyngeal swab, a nasal swab, and a nasopharyngeal swab, or a combination of the same.

Additional aspects of the invention may include a microfluidic diagnostic device having an adaptor and a sample collector that comprise separate, or a single integral component. In a preferred embodiment, the adaptor of the invention may include a coupler formed by a tapered channel, and may further include a seal comprising a O-ring seal, or an integral extension that may be further configured to mate with a corresponding catch position positioned on the inside surface on the interface channel.

Additional aspects of the invention may include a microfluidic diagnostic device having a reaction mixture containing one or more buffers, one or more reagents, or a combination of the same.

Additional aspects of the invention may include a microfluidic diagnostic device having a cap secured to the external aperture of an interface channel. In a preferred aspect, the cap of the invention may include a removable cap, such as a foil cap that can be removed by a user, or a cap that is configured to be punctured by a user, and preferably by a sample collector of the invention.

Additional aspects of the invention may include a microfluidic diagnostic device having a housing containing an exemplary microfluidic testing device. In a preferred aspect, a microfluidic testing device of the invention may include a lateral flow assay device, a lab-on-a-chip (LOC) device, or other microfluidic testing device known in the art or described herein.

Additional aspects of the invention may include a microfluidic diagnostic device including a biological sample loader comprising, in a preferred aspect: a cap holder, a joint, and optionally one or more fasteners.

Additional aspects of the invention may include a method of testing a biological sample. In a preferred aspect, the method of the invention may include the steps of securing an adaptor to a sample collector, wherein the sample collector may include a collected biological sample, or alternatively may be used to collect a biological sample while attached to the adaptor. The sample collector of the invention may be introduced to a reaction mixture positioned within an interface channel, wherein the adaptor forms a seal with the interface channel. The interface channel may be pressurized causing the perforation of a membrane positioned between the reaction mixture and the microfluidic testing device of the invention and causing the biological sample and the reaction mixture to be introduced to the microfluidic testing device.

Additional aspects of the invention may include a method of testing a biological sample, wherein the step of pressurizing the interface channel of the invention includes the step of depressing the adaptor into the interface channel. In one preferred aspect, a seal on the adaptor may engage with one or more catch positions positioned on the internal surface of the interface channel of the invention.

Additional aspects of the invention may include a method of testing a biological sample, including the step of agitating the reaction mixture and said biological sample positioned within the interface channel.

Additional aspects of the invention may include a method of testing a biological sample, including the step of filtering the reaction mixture and biological sample prior to being introduced to a microfluidic testing device.

Additional aspects of the invention may include a method of testing a biological sample, including the step of introducing a sample collector to an interface channel with a biological sample loader. In a preferred aspect, this method may include the step of securing a sample collector and adaptor with a cap holder and engaging a joint to insert the sample collector through the external aperture of the interface channel, and optionally fastening the joint and cap holder to the interface channel.

Additional aspects of the invention may be evidenced from the specification, claims and figures provided below.

### BRIEF DESCRIPTION OF THE DRAWINGS

The novel aspects, features, and advantages of the present disclosure will be better understood from the following detailed descriptions taken in conjunction with the accompanying figures, all of which are given by way of illustration only, and are not limiting the presently disclosed embodiments, in which:

FIGS. 1A-D: (A) shows a front perspective view of a microfluidic diagnostic device having as integral interface channel configured to accept a sample collector and responsive to a biological sample loader in one embodiment thereof; (B) shows a top view of a microfluidic diagnostic device having an integral interface channel configured to accept a sample collector and responsive to a biological sample loader in one embodiment thereof (C) shows a top view of a microfluidic diagnostic device formed by a housing having top and bottom components, where the top components of the housing incudes as integral interface channel configured to accept a sample collector and responsive to a biological sample loader, and the bottom housing comprises a flat surface that forms a cavity with said top portion to secure a microfluidic testing device in one embodiment thereof; (D) shows a side perspective view of a microfluidic diagnostic device having as integral interface channel configured to accept a sample collector and responsive to a biological sample loader in one embodiment thereof;

FIGS. 2A-B: (A) shows an isolated view of an adaptor and a sample collector, wherein the adaptor includes a coupler formed by a tapered channel, and an integral extension component in one embodiment thereof; (B) shows a cross-sectional side view of a microfluidic diagnostic device having a reaction mixture contained within an interface channel and separated from an exemplary microfluidic testing device by a membrane and a filter in one embodiment thereof;

FIG. 3A-B: shows a cross-sectional side view of a microfluidic diagnostic device having an adaptor securing a sample collector positioned within an interface channel in one embodiment thereof; (B) shows a cross-sectional side view of a microfluidic diagnostic device having an adaptor securing a sample collector positioned within an interface channel wherein the sample collector is perforating a membrane and filter in one embodiment thereof; and

FIG. 4: shows an exemplary microfluidic testing device having multiple microfluidic channels and reaction chambers that could be positioned within a housing of the invention and receive a pressurized reaction mixture containing a biological sample as described herein in one example thereof.

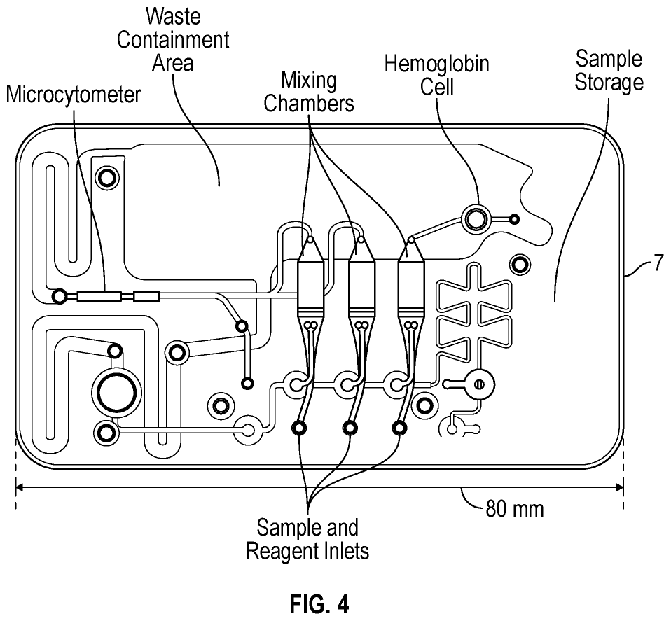

### DETAILED DESCRIPTION OF THE INVENTION

The present invention includes novel systems, methods, and apparatus for a microfluidic diagnostic device (1). In a preferred embodiment, the microfluidic diagnostic device (1) of the invention may be configured to pressurize and deliver a biological sample (19), and preferably a liquid biological sample (19), to a microfluidic testing device (7).

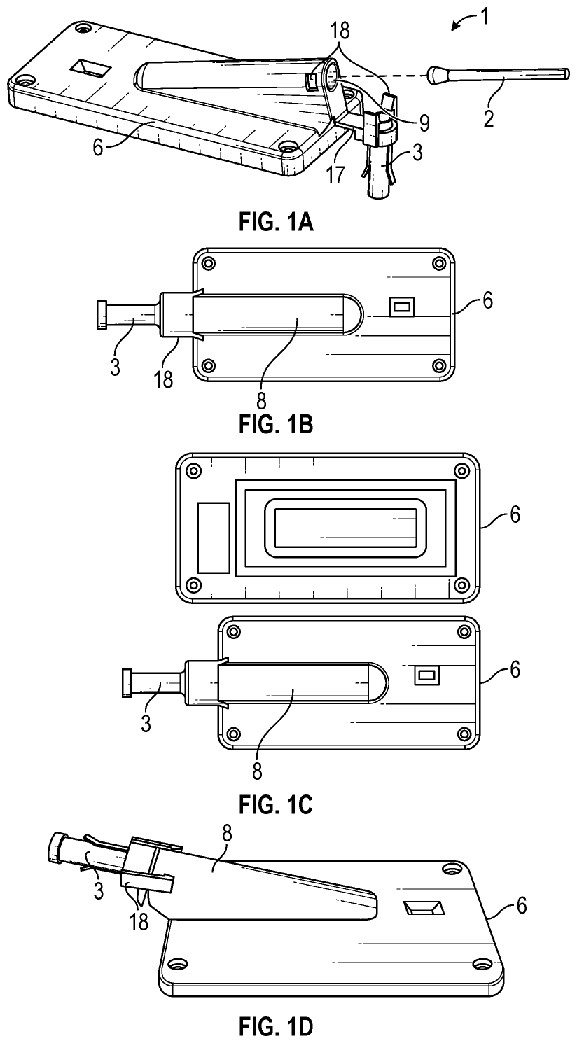

The microfluidic diagnostic device (1) of the invention may be configured to secure one or more microfluidic testing devices (7) configured to receive a pressurized a biological sample (19). In one preferred embodiment, the microfluidic diagnostic device (1) of the invention may include a housing (6) configured to secure a microfluidic testing device (7). As generally referred to FIG. 1, the housing (6) of the invention may include multiple securable components, or alternatively may be a unitary integral component configured to house a one or more microfluidic testing devices (7) in series or in parallel. In the preferred embodiments described herein, the housing (6) of the invention may be formed of a plastic or other similar material, preferably through injection molding, hot embossing, 3D printing or similar production processes. Each housing (6) may be customized in size, shape, and orientation to secure a variety of different microfluidic testing devices (7), such as a lateral flow assay, or a microfluidic testing device (7) containing one or more microchannels and/or microchambers for chemical reactions or analysis.

The microfluidic diagnostic device (1) of the invention may further be configured to receive and facilitate the pressurized transfer of a biological sample (19) to one or microfluidic testing devices (7), wherein the pressure generated by the device performs work within the microfluidic environment of the device facilitating faster, and more accurate diagnostic testing. In a preferred embodiment, the microfluidic diagnostic device (1) of the invention includes a sample collector (2), which may include a generalized instrument that is capable of collecting a biological sample (19), preferably a bodily fluid collected from a human or other mammalian subject. In a preferred embodiment, a bodily fluid from a subject may include, but not be limited to: blood, serum, urine, saliva, tissues, cells, and organs, or a combination of the same.

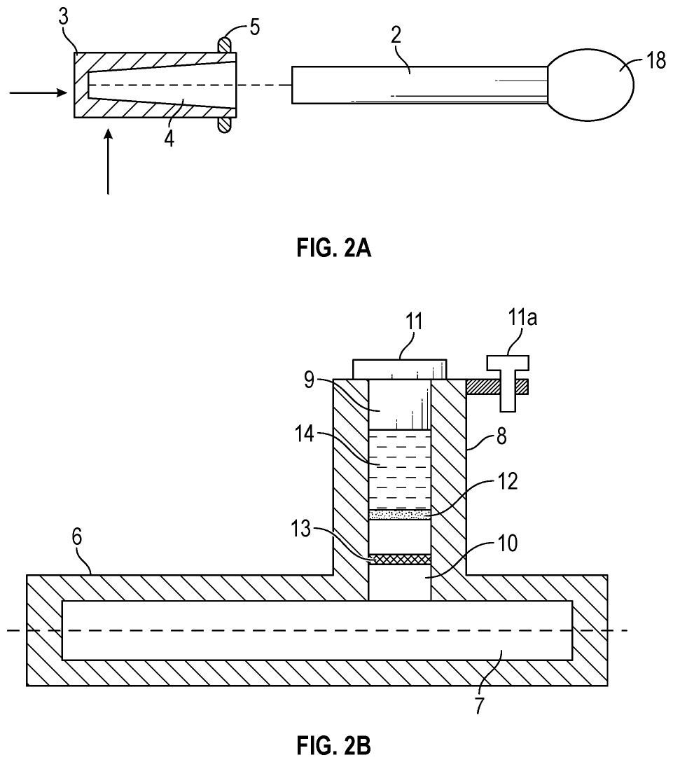

As shown in FIGS. 1 and 2, in a preferred embodiment, the sample collector (2) of the invention may include a specimen collection swab, such as an off the shelf swab for the collection of a biological sample (19). While a traditional cotton swab has been demonstrated as a preferred embodiment, a specimen collection swab of the invention may include, but not be limited to: a flocked swab, a foam swab, a rayon swab, an oropharyngeal swab, a nasal swab, and a nasopharyngeal swab, or a combination of the same. In alternative embodiments, a sample collector (2) of the invention may include a syringe containing a biological sample (19) that can be configured to deliver, preferably under pressure, a biological sample (19) to a reaction mixture (14) positioned within an interface channel (8) as detailed below.

The microfluidic diagnostic device (1) of the invention may further include an adaptor (3). The adaptor (3) of the invention may include a coupler (4) configured to secure a sample collector (2). In the preferred embodiment shown in FIG. 2A, the coupler (4) of the invention includes a tapered channel that runs axially through the center of the adaptor (3) that may accommodate and hold the terminal end of a sample collector (2). In this embodiment, the sample collector (2) is shown as a traditional swab used for contacting a bodily fluid or other biological sample. While the tapered channel may secure the terminal end of a sample collector (2) utilizing a frictional force, alternative embodiments of the invention may include mechanical couplers (4) configured to directly secure the sample collector (2) to the adaptor (3) of the invention. As shown in FIG. 2A, the adaptor (3) and sample collector (2) of the invention are shown as separable components, while in alternative embodiments the adaptor (3) and sample collector (2) may include a single integral component.

The microfluidic diagnostic device (1) of the invention may further include an interface channel (8). In a preferred embodiment, the interface channel (8) of the invention may be an approximately cylindrical channel having an external aperture (9) and an internal aperture (10). As generally shown in FIG. 1, the interface channel (8) of the invention may be an integral component of a housing (6), while in alternative embodiments, the housing (6) and interface channel (8) can be separable.

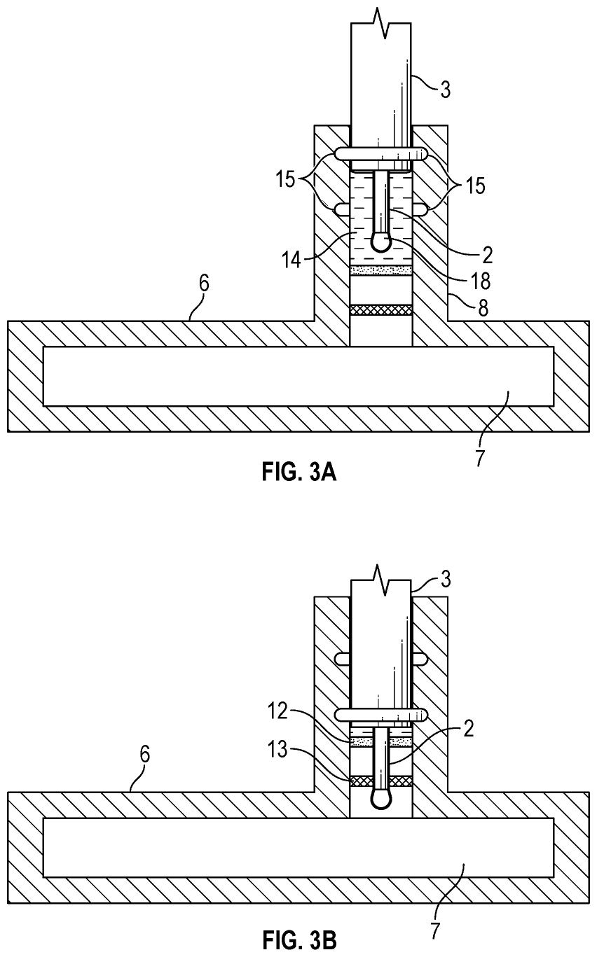

As shown in FIGS. 2-3, the interface channel (8) of the invention is configured to hold a quantity of a reaction mixture (14), which may include a buffer, or one or more reagents, or a combination of the same. In a preferred embodiment, the reaction mixture (14) of the invention is pre-loaded into the interface channel (8) through the external aperture (9). A membrane (12), and preferably a non-permeable membrane, is positioned at the distal end of the interface channel (8) preventing the reaction mixture (14) from freely flowing through the internal aperture (10) and into a microfluidic testing device (7), such as a lateral flow assay device or a lab-on-a-chip (LOC) device, positioned below the interface channel (8). In this embodiment, if not for the membrane (12) the microfluidic testing device (7) would be in fluid communication with the internal compartment of the interface channel (8) containing the reaction mixture (14).

The interface channel (8) of the invention may include a cap (11) secured to an external aperture (9). In this preferred embodiment, the cap (11) of the invention may prevent contamination of the reaction mixture (14) positioned within the interface channel (8). As described below, in a preferred embodiment, the cap (11) of the invention may be configured to be removed prior to introduction of the sample collector (2) into the interface channel (8). As shown in FIG. 2B, the cap (11) of the invention may include a foil cap configured to be removed or punctured by the sample collector (2). In alternative embodiments, the cap (11) of the invention may be a removable plug that may further be hinged (11a), or alternatively a threaded cap, configured to be secured to the external aperture (9) of the interface channel (8).

As generally show in FIGS. 2-3, the adaptor (3) of the invention may be configured to form a seal with the internal compartment of interface channel (8). This may be accomplished by inserting the adaptor (3) through the external aperture (9) such that the side-walls of the adaptor (3) are positioned adjacent to the internal side-wall of the interface channel (8) forming a seal. As shown in FIG. 3A, in an alternative preferred embodiment, the adaptor (3) of the invention may include a seal (5), such as an O-ring seal, or an integral extension that forms an air-tight coupling with the internal side-wall of the interface channel (8). Again, as shown in FIG. 3, the internal side-wall of the interface channel (8) may include one or more catch positions (15) configured to mate with the seal (5) of the adaptor facilitating the generation of an air-tight sealed coupling. In this configuration, depression of the adaptor (3) into the interface channel (8) generates a pressurized environment.

In one embodiment, a plurality of catch positions (15) may be placed along the inner surface of the interface channel (8). Each catch position (15) may correspond to a discrete position that signals to a user that a certain pressure has, or has not been reached. For example, in one embodiment, the adaptor (3) may be inserted into the external aperture (9) of the interface channel (8) such that the seal (5) engages with a first catch position (15). This first catch position (15) may be positioned to allow the sample collector (2) containing a biological sample (19) to be inserted into the reaction mixture (14) without generating a sufficient pressure differential across the membrane (12) of the invention to cause it to perforate. This may allow a user to ensure the biological sample (19) is transferred from the sample collector (2) to the reaction mixture (14) prior to its introduction into the microfluidic testing device (7). In an alternative embodiment, once the biological sample (19) is transferred from the sample collector (2) to the reaction mixture (14), a user may further depress the adaptor (3) such that the seal (5) engages with a second catch position (15). This second catch position (15) may correspond with the generation of a sufficient pressure differential to cause the perforation of the membrane (12), while also providing a signal to the user to stop depressing the adaptor (2) such that the sample collector (2) does not puncture the filter (13) as shown in FIG. 3B.

As previously noted, the membrane (12) of the invention may be configured to perforate in response to a differential pressure created across the membrane (12) by the depression of the adaptor (3) into the interface channel (8). In a preferred embodiment, the pressure differential generated across the membrane that may cause it to perforate can preferably be between 0.1 and 10 psi, or greater than 10 psi. Upon perforation of the membrane (12) the reaction mixture containing a biological sample (19) is in fluid communication with a microfluidic testing device (7). As noted above, as a result of the operation of the microfluidic diagnostic device (1) of the invention, the reaction mixture containing a biological sample (19) is introduced under pressure to a microfluidic testing device (7) where the pressure allows for the enhanced operation or work performed by the device.

In another preferred embodiment, a filter (13) can be positioned between the membrane (12) and the internal aperture (10) of the interface channel (8). In this embodiment, the filter (13) of the invention may filter and remove material from the reaction mixture (14) that may cause it to have a low viscosity which may alter the expediency and accuracy of the results. The filter (13) of the invention also acts a flow regulating element, providing resistance to the pressure generated in the interface channel (8) and delivering the reaction mixture (14) containing a biological sample (19) to a microfluidic testing device (7) at a consistent rate. In an alternative embodiment, a filter (13) can be positioned in the interface channel (8) between the reaction mixture (14) and the membrane (12). In this embodiment, the filter (13) the invention may filter and remove material from the reaction mixture (14) that may cause it to have a low viscosity which may alter the expediency and accuracy of the results prior to it passing through the perforated membrane.

The microfluidic diagnostic device (1) of the invention may further include a biological sample loader comprising a cap holder (16), a joint (17), and optionally one or more fasteners (18). Generally referring to FIG. 1, biological sample loader of the invention may facilitate the introduction of a sample collector (2) containing a biological sample (19) to the interface channel (8). In this preferred embodiment, a sample collector (2) may be secured to an adaptor (3) positioned within a cap holder (16). Once the sample collector (2) has been secured, it may be inserted into the interface channel (8) through the external aperture (9) by engaging a joint (17), and optionally fastening the joint (17) and cap holder (16) to the interface channel (8), for example to allow agitation of the reaction mixture (14) and biological sample (19). The adaptor (3), while being maintained in the cap holder (16) may further be depressed into the interface channel (8) generating a pressure differential across a membrane (12) as generally described above.

The present invention further includes method of testing a biological sample as described above. In a preferred embodiment, a biological sample (19) may be collected from a subject, and preferably a human subject. This biological sample (19) may include one or more bodily fluids from a subject that are contacted with a sample collector (2), such as a swab as described herein. The sample collector (2) containing the biological sample (19) may be coupled to an adaptor (3), such as by positioning the terminal end of the sample collector (2) within a tapered channel on the adaptor (3). In a preferred embodiment, a user may first remove a cap (11) from the external aperture (9) of the interface channel (8) exposing the reaction mixture (14). Next, the sample collector (2) containing the biological sample (19) is introduced to the reaction mixture (14) positioned within an interface channel (8) such that upon insertion the adaptor (3) forms a seal with the interface channel (8). While the sample collector (2) containing the biological sample (19) is in contact with the reaction mixture (14), it may be agitated to allow the biological sample (19) to be transferred from the collector to the mixture.

Next, a user may pressurize the interface channel (8) by depressing the adaptor (3) the interface channel (8). The resulting pressure differential created by the depression of the adaptor (3) causes a membrane (12) positioned between the reaction mixture (14) and a microfluidic testing device (7) to perforate, allowing the biological sample (19) and reaction mixture (14) to be introduced under pressure to the microfluidic testing device (7). In a preferred embodiment, the microfluidic diagnostic device (1) of the invention is positioned approximately horizontal prior to pressurizing the interface channel (8). In still further embodiments, prior to the pressurized introduction into the microfluidic testing device (7), the biological sample (19) and reaction mixture (14) may pass through a filter. This filtering step may remove material from the reaction mixture (14) that may cause it to have a low viscosity which may alter the expediency and accuracy of the results. The filter (13) of the invention also acts a flow regulating element, providing resistance to the pressure generated in the interface channel (8) and delivering the reaction mixture (14) containing a biological sample (19) to a microfluidic testing device (7) at a consistent rate.

As used herein, a “microfluidic testing device” refers to a device that uses capillary action, or external pumping device to drive the flow, mixing, or reactions occurring in a fluid sample. In one embodiment, a microfluidic testing device may include a diagnostic lateral flow assay that use capillary flow of liquids for the detection of analytes or other reactions or markers.

As used herein, a “lateral flow assay,” means an assay where the sample flow takes place at least partly parallel to a surface through which the sample and/or chemical or physical phenomena contributed by the sample can be optically imaged. In one embodiment, a lateral flow assay may include an immunochromatographic determination of the presence or absence of an antigen in a biological sample (19) from an subject by: a) combining the sample with a coloring agent-coupled antibody, specific for the antigen, as well as other detection methods known in the art, such as fluorescence, electrochemistry, and chemiluminescence; b) allowing the resulting combination to migrate into a first region containing a second antibody to the antigen, which is not coupled to a coloring agent so that the appearance of color in the first region indicates that the antigen is present in the sample; and c) allowing the combination to migrate from the first region into a second region containing an antibody to the first antibody, so that the appearance of color in the second region, together with the absence of color in the first region, serves as a control which indicates that the antibody to the antigen is present, but the antigen is not present; d) allowing the antigen-antibody complex to migrate from the first region into a second region where it is detected by a biosensor or any other electronic detection systems. Typical lateral flow methods are described in U.S. Pat. No. 6,656,744, which is hereby incorporated by reference in its entirety.

As used herein, “microfluidic testing device,” as used herein also refers to a device, and preferably a diagnostic device, comprising at least one inlet and outlet which are connected to each other via a microchannel. The microfluidic testing device can further comprise a microchamber for constant chemical reaction or analysis. The microchannel can have various shapes of cross-section, for example, circular, rectangular, semi-circular or trapezoid cross-section, but is not limited thereto. The microfluidic testing device can further comprise a sensor in contact with one or more microchannels and/or a microchamber. A lab-on-a-chip or LOC is an exemplary type of microfluidic testing device.

As used herein, “microfluidic testing device” also refers to a device, and preferably a diagnostic device, comprising at least one inlet and outlet which are connected to each other via a microchannel. The microfluidic device can further comprise a microchamber for constant chemical reaction or analysis. The microchannel can have various shapes of cross-section, for example, circular, rectangular, semi-circular or trapezoid cross-section, but is not limited thereto. The microfluidic device can further comprise a sensor in contact with one or more microchannels and/or a microchamber. A lab-on-a-chip or LOC is a type of microfluidic device.

The term “subject” refers to any animal. In certain embodiments, the subject is a mammal. In certain embodiments, the subject is a human (e.g., a man, a woman, or a child). The human may be of either sex, or may be at any stage of development.

As used herein, “buffer” refers to a substance, which is typically a solution, that maintains a stable pH despite the addition of strong acids or bases and external influences of temperature, pressure, volume or redox potential. The buffer prevents changes in the concentration of additional chemicals, such as proton donor and acceptor systems, to prevent significant changes in hydrogen ion concentration (pH). The pH of all buffers is temperature and concentration dependent. The choice of buffer to be used to maintain the pH or pH range can be determined empirically by one skilled in the art based on the known buffering capacity of known buffers. Exemplary buffers include, but are not limited to: bicarbonate buffer, dimethylarsinate buffer, phosphate buffer or Tris buffer. For example, Tris buffer (tromethamine) is an amine-based buffer having a pKa of 8.06 and having an effective pH range of 7.9-9.2. For Tris buffer, the pH increased by about 0.03 units for every 1° C. decrease in temperature and decreased by 0.03-0.05 units for every 10-fold dilution.

As used herein “reagent” can refer broadly to any chemical or biochemical agent used in a reaction, including enzymes. A reagent can include a single agent which itself can be monitored or a mixture of two or more agents. A reagent may be living (e.g., a cell) or non-living. Exemplary reagents can include at least one of, but are not limited to, a lysis buffer, salt, a bead, a protease, an enzyme, a metal ion (for example magnesium salt), chelator, polymerase, primer, template, nucleotide triphosphate, label, dye, nuclease inhibitor, substrates, chromogens, cofactors, coupling enzymes, buffer, metal ions, inhibitors and activators, and the like.

1. A microfluidic diagnostic device comprising:
a sample collector containing a biological sample to be tested;
an adaptor having:
a coupler securing said sample collector;
a seal;
an interface channel containing a reaction mixture;
wherein said adaptor is inserted into said interface channel forming a seal and introducing said biological sample to said reaction mixture; and
a membrane separating said interface channel and a microfluidic testing device, wherein said membrane is configured to be perforated after depression of said adaptor thereby allowing pressurized fluid communication between said reaction mixture and said microfluidic testing device.

2-5. (canceled)

6. The device of claim 1, wherein said adaptor and said sample collector comprise a single integral component.

7. (canceled)

8. The device of claim 1, wherein said seal comprises an O-ring seal, or an integral extension.

9. The device of claim 8, further comprising one or more catch positions configured to mate with said seal.

10. (canceled)

11. The device of claim 1, wherein said membrane perforates in response to the pressurization generated by depression of said adaptor into said interface channel.

12. The device of claim 1, further comprising a filter positioned between said membrane and the internal aperture of said interface channel, or positioned between said membrane and said internal aperture of said interface channel.

13. The device of claim 1, further comprising a cap secured to the external aperture of said interface channel.

14. The device of claim 13, wherein said cap comprises a foil cap configured to be removed or punctured by said sample collector.

15-16. (canceled)

17. The device of claim 1, further comprising a biological sample loader comprising:
a cap holder;
a joint; and
one or more fasteners.

18-38. (canceled)

39. A system for testing a biological sample comprising:
a biological sample to be tested;
a sample collector;
an adaptor securing said sample collector, wherein said adaptor is inserted into an interface channel containing a reaction mixture and forming a seal;
a membrane separating said interface channel and a microfluidic testing device; and
a housing containing said microfluidic testing device.

40-43. (canceled)

44. The system of claim 39, wherein said adaptor and said sample collector comprise a single integral component.

45-46. (canceled)

47. The system of claim 39, wherein said adaptor comprises a seal.

48. The system of claim 47, wherein said seal comprises an O-ring seal, or an integral extension.

49. The system of claim 48, further comprising one or more catch positions configured to mate with said seal.

50. (canceled)

51. The system of claim 39, wherein said membrane perforates in response to the pressurization generated by depression of said adaptor into said interface channel.

52. The system of claim 39, further comprising a filter positioned between said membrane and said internal aperture of said interface channel positioned between said membrane and said internal aperture of said interface channel.

53. The system of claim 39, further comprising a cap secured to the external aperture of said interface channel.

54. The system of claim 53, wherein said cap comprises a foil cap configured to be removed or punctured by said sample collector.

55. (canceled)

56. The system of claim 39, wherein said microfluidic testing device comprises a lateral flow assay device, or a lab-on-a-chip (LOC) device.

57. The system of claim 39, further comprising a biological sample loader comprising:
a cap holder;
a joint; and
one or more fasteners.
